(19) United States
(12) Patent Application Publication
(10) Pub. No.: US 2011/0078870 A1
(43) Pub. Date: Apr. 7, 2011

(54) WINDSHIELD WIPER BLADE

(76) Inventor: LANCE OWENS, Fruita, CO (US)

(21) Appl. No.: 12/572,919

(22) Filed: Oct. 2, 2009

(51) Int. Cl. B60S 1/04

(52) U.S. Cl. 15/250.361

(57) ABSTRACT

The present invention relates to a wiper blade assembly for clearing the surface of a windshield comprising: a first blade edge, where said first edge is capable of contacting the surface of the windshield; a second blade edge, where said second edge is capable of contacting the surface of the windshield; and a scrubby surface between the first blade edge and second blade edge, where said scrubby surface is capable of contacting the surface of the windshield. The wiper blade assembly further includes a back plate that provides a means to attach the blade assembly to an arm assembly. The blade assembly of the present invention is capable of scrubbing away dirt and particle debris on a windshield.

### BACKGROUND OF THE INVENTION

1. Field of Invention

The present invention relates to a windshield wiper blade with a brush insert that provides a means for scrubbing debris off the surface of a windshield.

2. Description of Related Art

Windshield wipers provide a means to clear and wipe moisture, rain, and surface debris from the windshield of a vehicle. Windshield wipers include an arm assembly and a blade as the primary components. The blade comes into direct contact with the windshield and in most instances is made of a rubber substance that swipes and wipes the moisture off the surface of the windshield. The arm assembly is connected to an internal linkage and a motor that puts the assembly and blade into motion across the surface of the windshield.

The blade is the most critical component of the windshield wiper assembly since the blade is the device that comes into contact with the windshield and removes the moisture and debris to clear the windshield. Over time wiper blades get worn and streaks are left on the surface of the windshield and in certain instances where a significant amount of debris, dirt or other surface particles accumulate on the windshield, windshield wipers cannot effectively clear the view on the windshield. When the blade cannot effectively clear the windshield, the driver must stop and use other cleaning means and methods to clear the windshield. Most windshield wiper blades are a single blade edge construction that comes in contact with the windshield. However, windshield wiper blades are also comprised of dual triple and even quad edged blades that provide a further means to wipe and clear the windshield surface. In addition to multiple blade edges, some windshield wiper blades include a scrubbing surface, scrubbing edge or in some cases a sponge is placed in parallel with the windshield wiper blade to provide an additional means to clear debris and surface particles from the windshield.

Examples of wiper blades that include a sponge and scrubbing attachment include U.S. Pat. No. 5,301,384 that discloses a wiper blade and drive means in combination with the scrubber for intensifying the cleaning effect of a wiper blade where the scrubber is detachably connected to the wiper blade. U.S. Pat. No. 5,996,168 discloses a standard windshield wiper assembly that extends a scrubber blade to the surface of a vehicle windshield to dislodge remains and debris with the aid of the wiper motion. Yet another example of a wiper assembly includes U.S. Pat. No. 6,748,621, which discloses a set of windshield wipers designed to scrub insects off the surface of the windshield that includes the bridge member that has a first hand, a second hand and a medial portion. The blade member is provided to support a plurality of cleaning members and a cleaning blade.

Although some solutions have been created to attempt to address effective cleaning and wiping of windshield, further development of windshield wiper blades is needed to have yet more effective means for cleaning debris, moisture, and other surface particles from the windshield.

### SUMMARY OF THE INVENTION

The present invention relates to a wiper blade assembly for clearing the surface of a windshield comprising: a first blade edge, where said first edge is capable of contacting the surface of the windshield; a second blade edge, where said second edge is capable of contacting the surface of the windshield; and a scrubby surface between the first blade edge and second blade edge, where said scrubby surface is capable of contacting the surface of the windshield. The wiper blade assembly further includes a back plate that provides a means to attach the blade assembly to an arm assembly. The blade assembly of the present invention is capable of scrubbing away dirt and particle debris on a windshield.

### BRIEF DESCRIPTION OF DRAWINGS

FIG. 1A depicts the wiper blade according to the present invention.

FIG. 1B depicts the wiper blade according to the present invention attached to a wiper blade arm assembly.

### DETAILED DESCRIPTION

The present invention relates to a wiper blade assembly that includes the scrubbing surface lodged between dual wiper edges of a wiper blade. The scrubbing surface provides a means to remove debris and surface particles that may be on the windshield and therefore create an effective means of clearing the windshield during use. The blade assembly according to the present invention provides a scrubby surface between two edges of a conventional wiper blade.

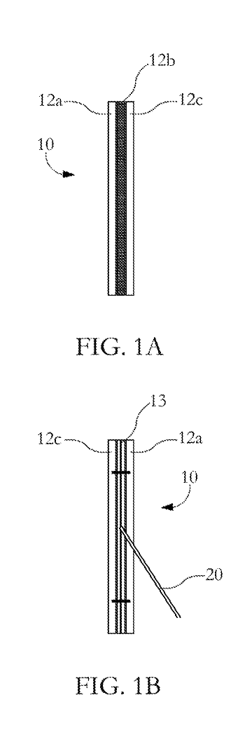

FIG. 1A depicts a wiper blade assembly 10 according to the present invention. The wiper blade assembly 10 includes an abrasive scrubby surface 12b and wiper blade edges 12a, 12c. As clearly depicted, the scrubby surface 12b lies between the wiper blade edges 12a, 12c. This configuration provides for the application of the scrubby surface between the wiping edges of the blades. Therefore, when one blade is applied to the surface of a windshield, the scrubby surface follows and the remaining wiper blade edge follows the scrubby surface. Thus, as the blades stroke across the surface of the windshield the scrubby surface 12b helps to remove particles and debris that may be left after the application of the wiper edge to the windshield. The wiper blade assembly 10 completely cleans the surface of a windshield when utilized on a conventional arm assembly of a vehicle.

FIG. 1B depicts the wiper blade assembly 10 attached to an arm assembly 20. The arm assembly 20 connects to linkage and a wiper motor not shown. The blade assembly 10 includes a back plate 13 that attaches to the arm assembly 20. The back plate 13 secures the wiper blade assembly 10 to the arm assembly 20 and ensures that the blade stays in place during use.

The wiper blade assembly 10 provides a windshield wiper blade that is capable of scrubbing away dirt and particle debris that may be on a windshield. The wiper blade assembly 10 therefore provides a more effective means to clean the windshield surface as opposed to a conventional windshield wiper. The scrubbing surface provided on the wiper blade assembly helps to improve visibility and prevent the need to manually wipe or clean the windshield surface in certain conditions. The wiper blade assembly 10 is very effective in removing spots, dust, and dirt that may lie on the surface of the windshield.

What is claimed is:

1. A wiper blade assembly for clearing the surface of a windshield comprising:
a. a first blade edge, where said first edge is capable of contacting the surface of the windshield;
b. a second blade edge, where said second edge is capable of contacting the surface of the windshield; and
c. a scrubby surface between the first blade edge and second blade edge, where said scrubby surface is capable of contacting the surface of the windshield.

2. The wiper blade assembly according to claim 1, where blade assembly further includes a back plate, where said backplate provides a means to attach the blade assembly to an arm assembly.

3. The wiper blade assembly according to claim 1, where said blade assembly is capable of scrubbing away dirt and particle debris on a windshield.
